(19) United States
(12) Patent Application Publication
(10) Pub. No.: US 2012/0266807 A1
(43) Pub. Date: Oct. 25, 2012

(54) SIGNAL ASSEMBLY

(76) Inventor: Jess Gordon Summers, Fruit Heights, UT (US)

(21) Appl. No.: 13/090,906

(22) Filed: Apr. 20, 2011

(51) Int. Cl. G09F 9/00

(52) U.S. Cl. 116/324

(57) ABSTRACT

A signal assembly has a handle that a person can move up and down, causing one or more reflective surfaces to be shown and hidden (“flash”) to alert a bus driver of a passenger's presence at a bus stop. The signal assembly may, for example, mount on a bus stop sign or a bus stop shelter. The flashing reflective surface may receive an oncoming bus' headlights and reflect the light to alert the driver. When the handle is not moved up and down, a reflective surface of the signal assembly may still be visible to the bus driver, alerting the bus driver of the presence of the stop. A driver who is not familiar with the route may find this useful, especially when a passenger indicates a request for the bus to stop at the next stop.

### BACKGROUND OF THE INVENTION

The present invention relates to signage and, more particularly, to a signal for a bus stop to alert a driver to stop.

After dark, it is difficult to see passengers at a bus stop. Thus, passengers waiting at a bus stop after dark are often missed. This not only inconveniences the bus rider that has missed his or her bus, but may also provide a safety issue, as the rider needs to wait for the next bus or find alternate transportation.

As can be seen, there is a need for signal to stop a bus that may be readily visible by the bus driver, even after dark.

### SUMMARY OF THE INVENTION

In one aspect of the present invention, a signal assembly comprises an inner member; at least one reflective surface on the inner member; and an outer member fitting about and slideable along the inner member.

In another aspect of the present invention, a signal assembly comprises an inner tube member; a first reflective surface on a first end of the inner tube member; a second reflective surface on a second end of the inner tube member; end caps disposed on each end of the inner tube member; an outer tube member fitting about and slideable along the inner member; and a handle on the outer tube member.

These and other features, aspects and advantages of the present invention will become better understood with reference to the following drawings, description and claims.

### BRIEF DESCRIPTION OF THE DRAWINGS

FIG. 1 is a perspective view of a bus stop signal according to an exemplary embodiment of the present invention;

FIG. 2 is an exploded perspective view of the bus stop signal of FIG. 2;

FIG. 3 is a top view of the bus stop signal of FIG. 1;

FIG. 4 is a side view of the bus stop signal of FIG. 1;

FIG. 5 is a side view of the bus stop signal of FIG. 1 in a down position; and

FIG. 6 is a side view of the bus stop signal of FIG. 1 in an up position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a signal assembly having a handle that a person can move up and down, causing one or more reflective surfaces to be shown and hidden (“flash”) to alert a bus driver of a passenger's presence at a bus stop. The signal assembly may, for example, mount on a bus stop sign or a bus stop shelter. The flashing reflective surface may receive an oncoming bus' headlights and reflect the light to alert the driver. When the handle is not moved up and down, a reflective surface of the signal assembly may still be visible to the bus driver, alerting the bus driver of the presence of the stop. A driver who is not familiar with the route may find this useful, especially when a passenger indicates a request for the bus to stop at the next stop.

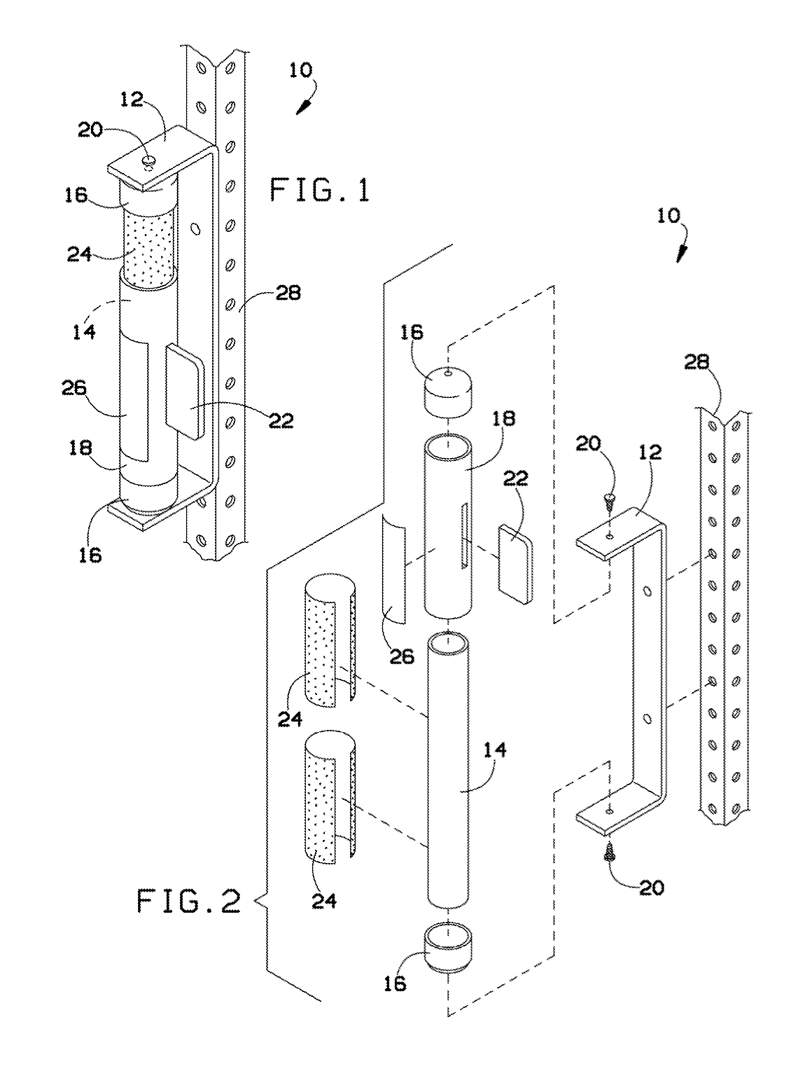

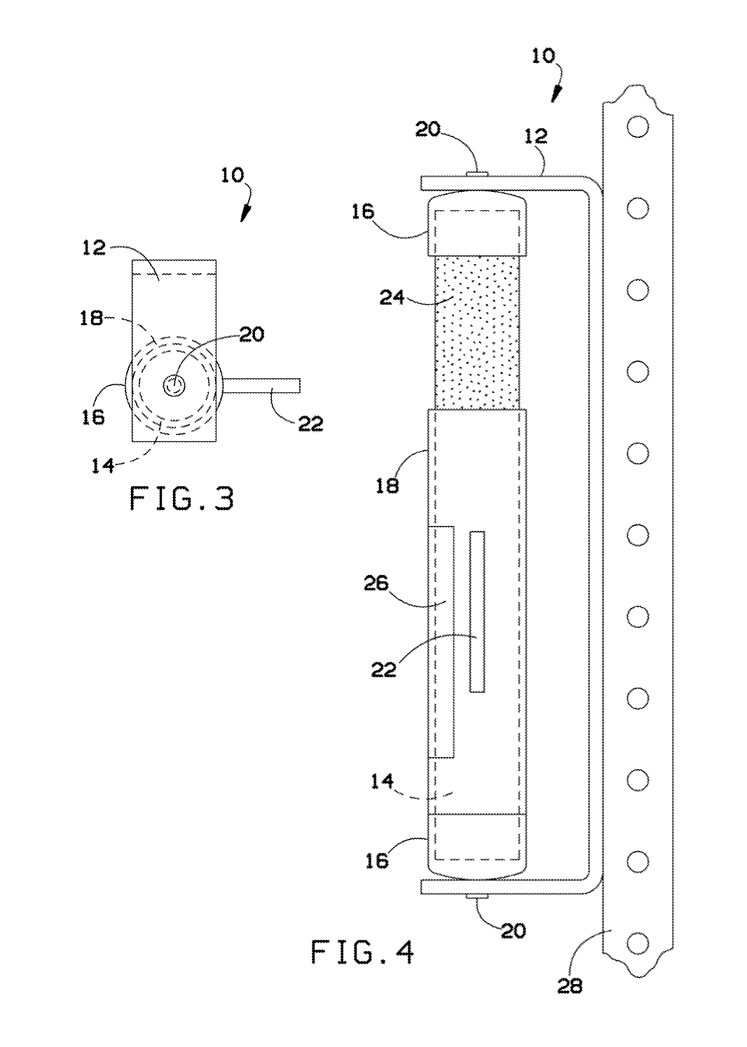

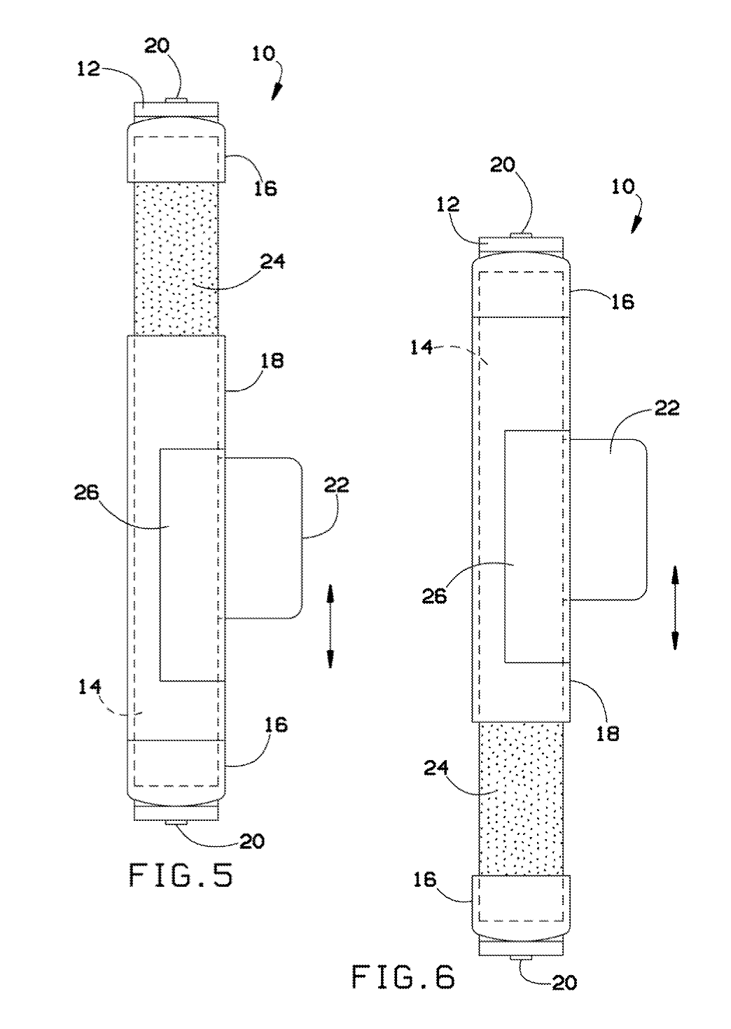

Referring to FIGS. 1 through 6, a signal assembly 10 may include a mounting bracket 12 that may attach to a mounting post 28. The mounting post 28 may be, for example, a bus stop sign. In some embodiments, the mounting post 28 may be a portion of a bus stop shelter.

The signal assembly may include an inner tube 14 having at least one reflective surface 24 thereupon. In some embodiments, the reflective surface 14 may be disposed on at least an upper end and a lower end of the inner tube 14. In some embodiments, the reflective surface 24 may be achieved with reflective tape, reflective paint, or the like. The inner tube 14 may be, for example, from about 1 to about 2 inches in diameter and from about 8 to about 16 inches long. Typically, the inner tube 14 may be made from 1½ inch white schedule 40 plastic tubing that is about 11⅝ inches long. The reflective surface 24 may extend about three inches from each end of the inner tube 14.

An outer tube 18 may slide over the inner tube 14. The outer tube 18 may be from about 1¼ to about 2¼ inches in diameter and from about 5 to about 9 inches long. Typically, the outer tube 18 may be 2-inch diameter black ABS plastic pipe that is about 7¼ inches long. A handle 22 may be adapted to move the outer tube 18 up and down along the inner tube 14. In some embodiments, the handle 22 may be attached directly to the outer tube 18. The handle 22 may be about 3 inches long and about 1½ inch high. In some embodiments, the handle 22 may be extended from the mounting post 28 to a location inside a bus shelter (not shown), thereby allowing the waiting passenger to move the handle 22 without leaving the bus shelter.

End caps 16 may be disposed on each end of the inner tube 14. The end caps 16 may retain the outer tube 18 on the inner tube 14. Holes may be formed in the end caps 16. Push pins 20 may be used to pass through holes in the mounting bracket 12 into the holes of the end caps 16. The end caps 16 may be secured to the mounting bracket 12 by other mechanisms. For example, a self-tapping screw may be used to pass through the mounting bracket 12 and into the end caps 16.

Typically, the inner tube 14 and the outer tube 18 may be cylindrical members having circular cross-sections. In some embodiments, the cross-sections of the tubes 14, 18 may be other shapes, such as square, rectangular, and the like.

A waterproof instruction sticker 26 may be applied to the signal assembly 10. The instruction sticker 26 may contain instructions describing how a user may move the handle up and down to alert the bus driver that there is a person waiting to be picked up at the bus stop. The instruction sticker 26 may provide instructions in one or more languages.

The signal assembly 10 may be made from standard materials, including, for example, PVC and ABS pipe. The mounting bracket 12 may be plastic, metal or the like. The tubing (inner tube 14, outer tube 18) may be made in any color, depending on the needs of the user.

It should be understood, of course, that the foregoing relates to exemplary embodiments of the invention and that modifications may be made without departing from the spirit and scope of the invention as set forth in the following claims.

What is claimed is:

1. A signal assembly comprising:
an inner member;
at least one reflective surface on the inner member; and
an outer member fitting about and slideable along the inner member.

2. The signal assembly of claim 1, further comprising a handle on the outer member.

3. The signal assembly of claim 1, further comprising end caps at the ends of the inner member, the end caps retaining the outer member about the inner member.

4. The signal assembly of claim 3, further comprising a mounting bracket for retaining the end caps while allowing the outer member to slide over the inner member.

5. The signal assembly of claim 1, further comprising first and second reflective surfaces at first and second ends of the inner member.

6. The signal assembly of claim 1, wherein the inner member and the outer member are cylindrical tubular members.

7. The signal assembly of claim 1, further comprising an instruction sticker disposed on the outer member.

8. A signal assembly comprising:
an inner tube member;
a first reflective surface on a first end of the inner tube member;
a second reflective surface on a second end of the inner tube member;
end caps disposed on each end of the inner tube member;
an outer tube member fitting about and slideable along the inner member; and
a handle on the outer tube member.

9. The signal assembly of claim 8, further comprising a mounting bracket for retaining the end caps while allowing the outer member to slide over the inner member.

10. The signal assembly of claim 9 further comprising a mounting post for attaching the mounting bracket.
